(19) United States
(12) Patent Application Publication
(10) Pub. No.: US 2002/0000057 A1
(43) Pub. Date: Jan. 3, 2002

(54) Universal portable illuminated artwork module

(76) Inventor: Edgar Mason Nash, Modesto, CA (US)

Correspondence Address: Edgar M. Nash, 4066 Elmo Loop, Modesto, CA, 95356, US

(21) Appl. No.: 09/878,456

(22) Filed: Jun. 12, 2001

Related U.S. Application Data
(60) Provisional application No. 60/211,199, filed on Jun. 13, 2000.

(51) Int. Cl. G09F 13/04

(52) U.S. Cl. 40/564

(57) ABSTRACT

A compact, portable backlighted artwork display unit so flexible it may be used in conjunction with any display device of choice, introducing entirely new art forms utilizing many variabtions of PLATEN and lighting diversity that may be combined or mixed to produce artistic dimensions and displays heretofore unknown.

### CROSS-REFERENCE TO RELATED APPLICATIONS

This application is entitled to the benefit of provisional patent application Ser. No. 60/211199 filed 2000, June 13.

### STATEMENT REGARDING FEDERALLY SPONSORED RESEARCH AND DEVELOPMENT

NON-APPLICABLE

### BACKGROUND—FIELD OF INVENTION

This invention relates to backlighted device to display artwork, specifically to a flexibly portable embodiment having a wide multiplicity of new art media applications.

An exhaustive scrutiny of prior art discloses no portable apparatus securable into any display device of choice, such as a picture frame, simply, quickly and effectively. Prior art does not enable direct application of an artwork onto a re-usable PLATEN coincidentally while said PLATEN is mounted onto a backlighted display device. Nor does prior art support multiple new art forms as taught, enabled and encouraged by present invention.

### OBJECTS AND ADVANTAGES

It is the object of present invention to enable multiple innovative new art modes permitted by the basic universal portable illuminated artwork module and to permit such diversification easily through classically elementary means.

Present invention usefully combines widely diversified elements and features unaddressed by prior art: Portability of module assembly permits endless substitution of any display device such as a picture frame of choice; simple and inexpensive structure; optimal diffusion of light permitting no bright spots or shadows on the artwork; A wide variation of light sources making possible exception artwork effects heretofore unattainable; endless substitution of platen-supported artwork either of artwork applied directly to or overlaying the platen; simple substitution of platen artwork including work that may be a compositly-layered buildup as in a collage work; a module assembly that is light in weight, and inexpensive to produce using several elements widely available commercially.

### SUMMARY

Present invention permits exceptional flexibility and creativity by means of a simple and inexpensive embodiment means to backlight any translucent planar artwork, being a completely new and unique at medium utilizing many variations of the PLATEN itself as the artwork, encouraging talented artists to express artistic dimensions heretofore not possible, and for which many new and innovative platens, lighting and sound effects may be controlled, mixed and/or combined to produce brilliant and delightful displays.

AN INNOVATIVE ARTIST'S DREAM!!

### DESCRIPTION OF THE INVENTION—MAIN EMBODIMENT

Present invention is compatible to embodiment in many differing modes, and while there will be described herinafter the preferred embodiment of the invention and options thereto, there is no implication that there are limitations to any ramifications suggested by art taught herein.

Referring to assembly No. 1, a system overview of preferred embodiment of present invention, it is disclosed that there are but four primary elements (Parts No's 10, 11, 12 and 13) comprising my universal portable illuminated artwork module (“Module”)

### 1) ARTWORK DISPLAY PLATEN (“PLATEN”), PART NO. 10,

Said PLATEN will sustain the artwork to be displayed and will match dimensions of the artwork proper, in preferred embodiment will be a clear and rigid sheet of plastic of sufficient strength and thickness to support any artwork such as a transparency and dimensioned to fit into and be contained within recessed front inner edge of artwork container frame (“Frame”), part No. 11 said PLATEN ideally also may be a sheet of glass, ceramic, metal, wood, plaster, etc., or any other material answering its required dimensions and physical requirements.

Platen in preferred embodiment is secured within the face of artwork containment frame (“Frame”), part No. 11, by means of any simple rotatable “clip” of sheet metal, plastic or any other suitable material, or may be secured by means of any of numerous devices dedicated to such utility, such as spring clamps.

A separate artwork not depicted directly onto or into the PLATEN is attached to said PLATEN by means of simple rotatable clips made of metal, plastic, ceramic and the like, sized to accomodate varied thicknesses of separate artwork, or by any other attachment means such as clamps, slide latches, spring clamps or any other such devices well known to the art.

2) ARTWORK CONTAINMENT FRAME (“FRAME”), PART NO. 11

In preferred embodiment frame typically retains edges of platen, and is assembled of sectionally mitered lengths of wooden moulding. It is obvious that material used also may be plastic, metal, ceramic, glass or any organic/inorganic composition of durable and machinate character. The section of frame is modified as required for functionality relating to thicker sheets of work to be displayed, or as required by more than one light diffusion sheet (“Sheet”) (Part No. 12), or as required to accomodate heavier and larger artworks, or any other causative reason(s).

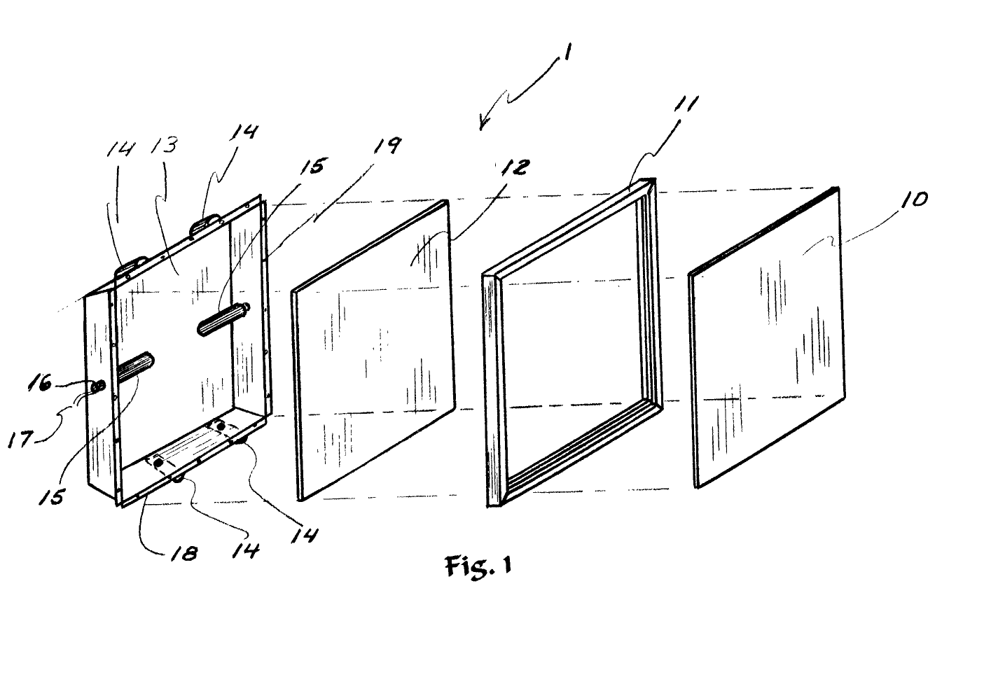

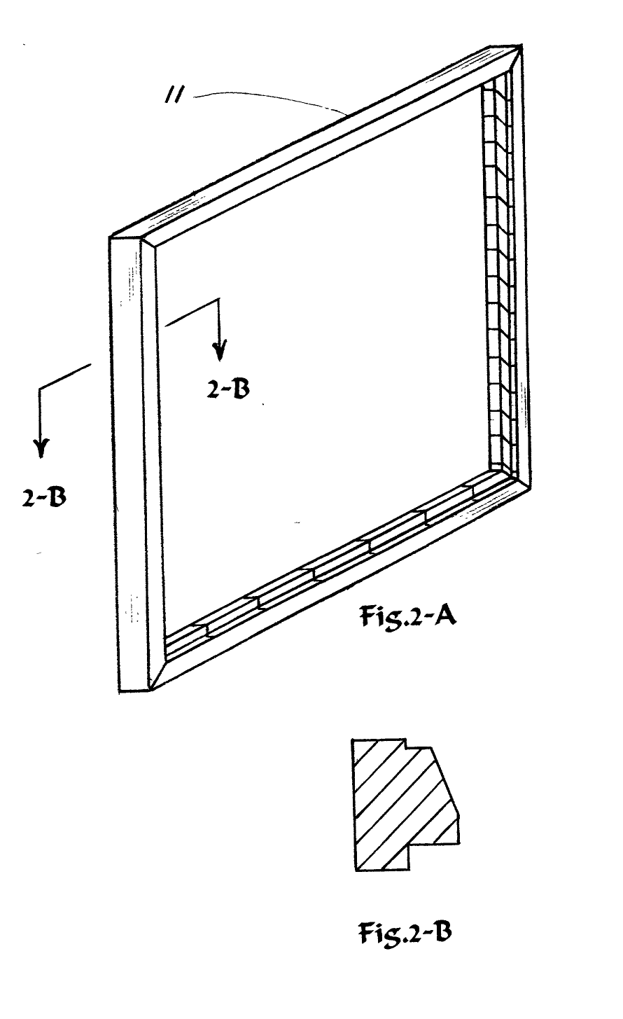

In preferred embodiment frame has all inner surfaces finished in a light-reflective media such as paint, metallic paint, silvering (for clear, transparent materials), tin plating, or any other means fitted to the task of effectively reflecting light from all inner portions of frame. This coating applies especially to inner “BEVELLED” sloping faces (See FIG. 2-B).

3) LIGHT DIFFUSION SCREEN (“SCREEN”) PART NO. 12

In prefferred embodiment screen is dimensioned to fit into and be confined in back surface of frame within recessed inner ledges therein, and made of any clear sheets configured to disperse widely light emissions from any light source within module. Acrylic is preferred material. Such sheets have been in use for many years on ceiling-mounted fluorescent light boxes. Said sheets are secured within back of frame, upon recessed inner ledges by means of four or more flat-head screws as required for service in metal, wood, plastic, etc. A plurality of screens may be employed if desired, in order to more thoroughly scatter light from ventilated light box.

4) VENTILATED LIGHT BOX (“BOX”) PART NO. 13

Preferred embodiment of box is formed of a clear, rigid, heat-tolerant plastic such as acrylic, exterior surfaces of which have been made light-reflective inwardly by means of silvering, metallic paint, silver leaf, paint, or any other means of relective character.

Sides of box slope inwardly and backwardly at a twenty-degree angle (which optionally may be altered as conditions warrant). Sides and back panel may be dished concavely outward. Top and bottom sloped surfaces are pierced by two holes each, of approximately e,fra 3/4″ diameter, for ventilation purposes, the holes being proximate to the back of the box. Additional such holes may be provided for larger units or for those supporting multiple light sources if such sources emit heat. Side sloped surfaces of box also are pierced by holes for installation of light sources, with hole diameters determined by requirement of light sources selected. Preferred light sources are incandescent and fastened into sockets such surface mounted cleat lampholder as provided commercially by levitton MFG. Co.

Box is secured into back of frame by means of light box attachment flanges (Part No. 18) by preferred means of 8 flat-head screws passed through light box attachment flange screwholes. Then passing through edges of light diffusion screen(s) and thus into ACF proper.

5) VENTILATION FLUES (“FLUES”)—PART No. 14

Flues are designed to inhibit exit of light from open end of flue, and in preferred embodiment are formed of dark plastic heat-tolerant formable fine mesh having openings between cross-filaments sufficiently small as to suppress exit of light. Such flues are secured to body of box by means of heat-resistant cement or adhesive.

6) LIGHT SOURCE PART NO. 15

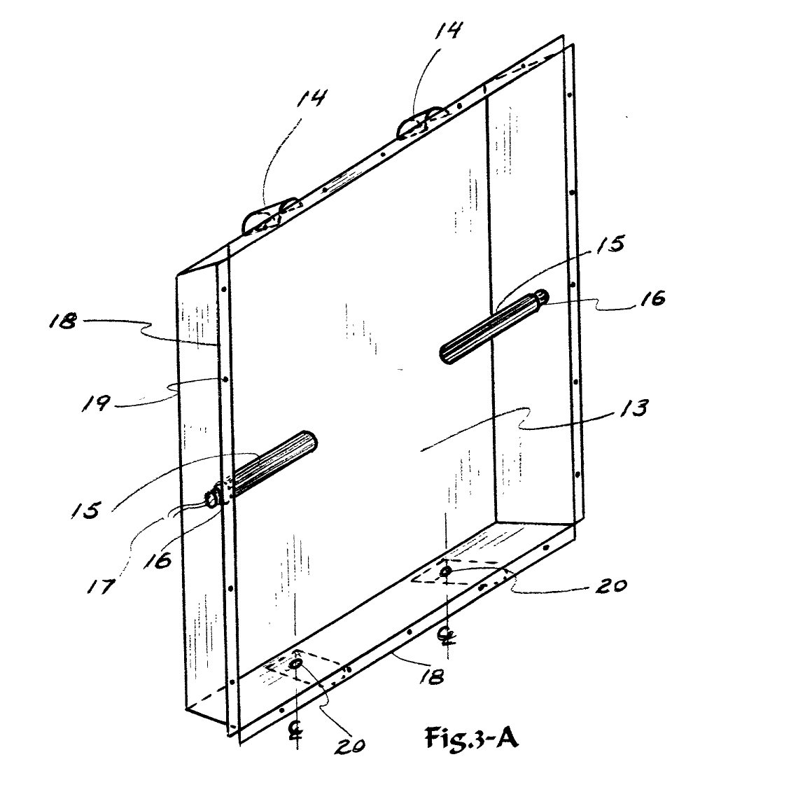

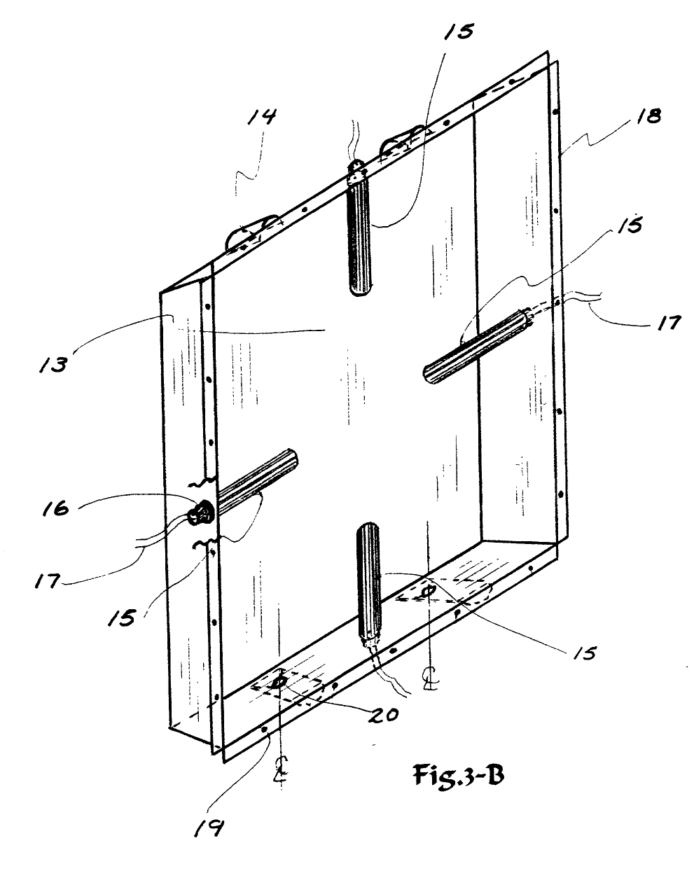

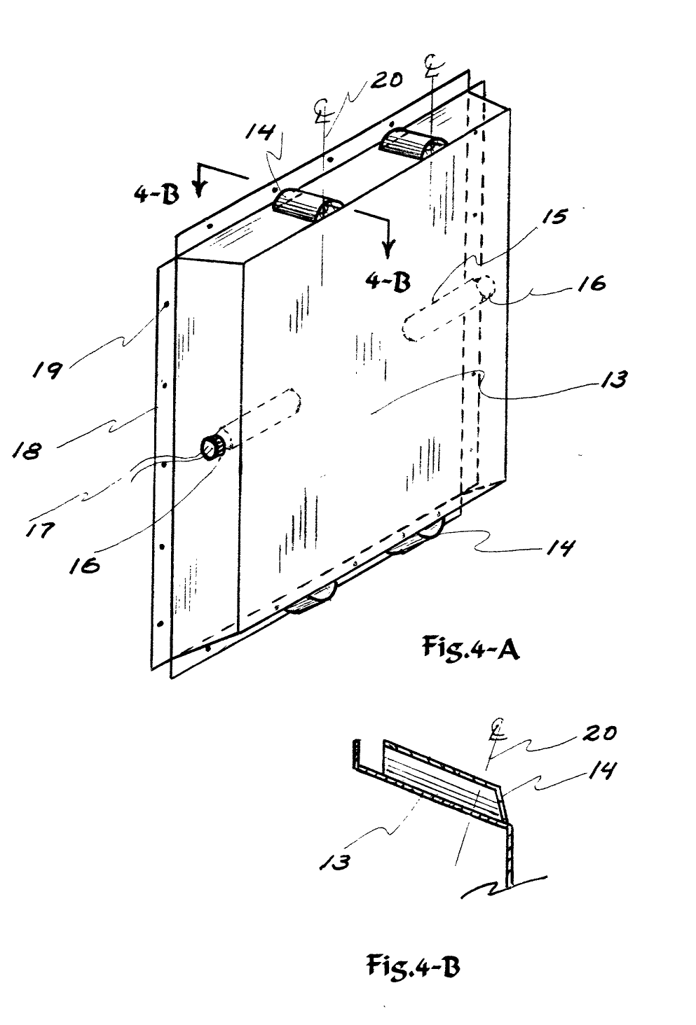

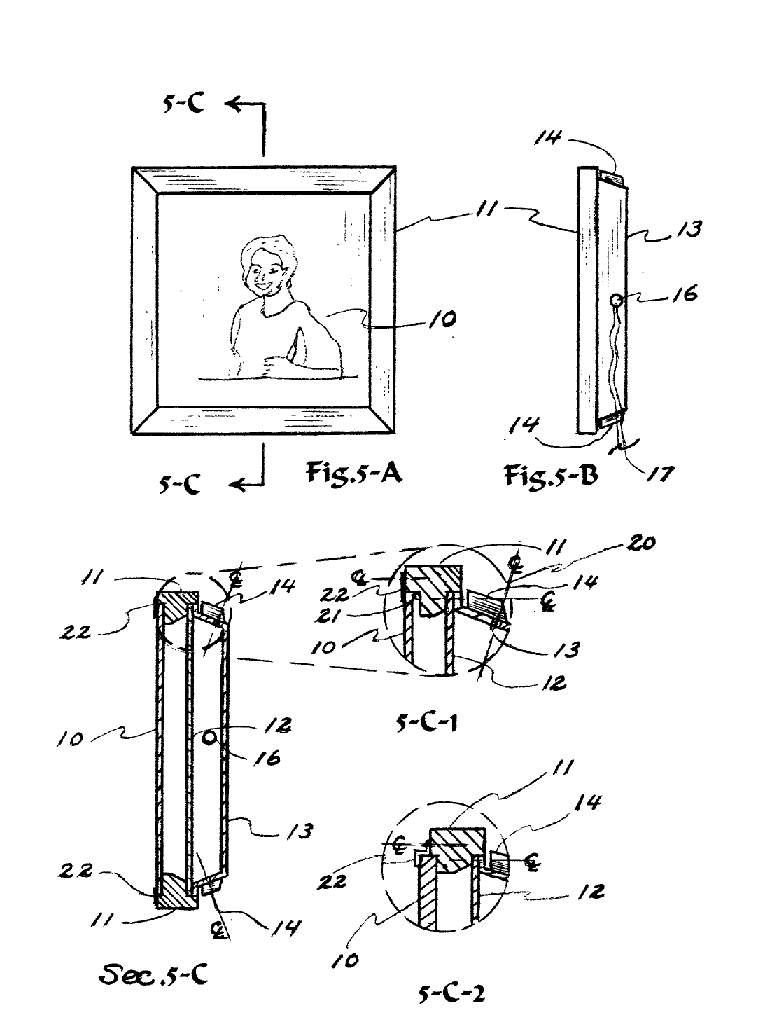

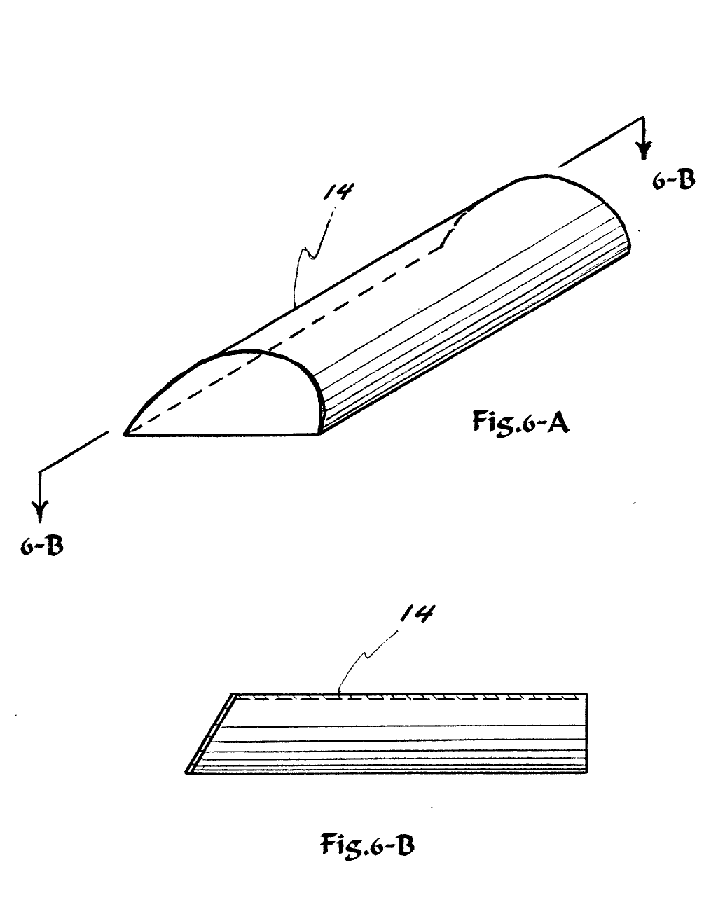

Light sources in preferred embodiment are conventional incandescent bulbs, available commercially. Conventional light sources shown (FIG. 3-A) are coated on one entire side, covering half the “BULB” with a reflective media such as silvering, metallic paint, ceramic, or any other media tolerant of heat, with coated side reflecting light from light source backward and sideward without allowing viewer to be distracted by direct light from light sources.

7) LIGHT SOURCE SOCKET PART NO. 16

Socket in preferred embodiment is levitton MFG. Co. surface mounted cleat lampholder, size for small-base light blubs supplying up to 125 watts of illumination.

8) POWER CORD PART NO. 17

Commercially available power cords in preferred embodiment supplying light sources are concealed within nipples or other such devices, and gathered at base of box to a single cable connected to power outlet. Holes provided for light source base are blocked by said light source devices so no light may exit.

9) LIGHT BOX ATTACHMENT FLANGE PART NO. 18

In preferred embodiment flange rigidly secures box to frame as described herein, and fastened by means of 8 flat-head screws (of type determined by service required, such as into wood, metal, plastic, ceramic, etc). Upon assembly of module, flange is placed atop edges of light diffusion screen(s) within recessed back of artwork containment frame, with fastening screws penetrating screen(s) into body of frame.

Part No. 19— light box attachment flange screwholes need no operating directions, as their function is apparent.

10) LIGHT BOX VENT HOLE (PART NO. 20)

Vent holes are placed as directed in prior description, in order to admit cool air at bottom of box and vent warm air upward and out through vent holes in top of box. Such convection is well known to the art and needs no instruction.

11) COMPRESSIBLE SPACER—PART NO. 21

Spacer is included in preferred embodiment only in event depth of mounting ledge for artword display PLATEN within inner edge of artwork containment frame exceeds thickness of platen. Spacer is any conventional compressible “PACKING” or “WEATHERSTRIPPING” of section meeting measure of space to be filled, in order to allow pressure to be exerted between periphery of artwork and mounting surface of ornamental (PICTURE) Frame. Such pressure prevents light exit toward viewer.

12) ARTWORK CLAMP—PART NO. 22

Clamp shown in preferred embodiment is simple, rotatable “CLIP”. Said clip may be obtained commerically or fabricated of sheet metal to fit.

### OPERATION OF THE INVENTION

It is implicit that dimensions of Module elements may be in/decreased at will in order to meet size/weight requirements of artworks as may be indicated.

A) Artwork Display Platen (“Platen”) Part No. 10

Preferred embodiment of present invention teaches employment of Module as a “portable” artwork display unit, wholly self-contained, that may be fixed into any suitable artwork display frame, which universal utility marks its portability feature. Module is attached to picture frame or any other such display device by conventional means such as blocking (with screws if needed), snap clamps, spring clamps, rotatable clamps or spring devices, or any other such simple device or technique currently in use.

Module may be wall mounted, table mounted, floor mounted, easel mounted, or any other such accommodation desired. In event viewer wishes to do so, Module may be fitted with a simple skirt to conceal its construction. Electrical power is fed to Module in conventional manner, from any convenient outlet, with a cord colored to satisfy.

Present invention teaches a wide array of optional choices relating to artwork media, artwork forms, artwork uses and artwork assembly to Platen. Majority of such options are simple derivations of conventional, however, a few are quite technical in nature albeit simple in description and manufacture. The latter are found in descriptions herein associative with wires or patterns thereof conductive to electricity, the ordered display of such patterns remotely controlled, and display of a multiplicity of Platens embraced by slidably reciprocal, alternate, successive or rotatable means. All such operation is achieved by means of devices or controls or manipulations currently available commercially. Similarly, sound may be employed within scopes and uses of innovations taught herein by inclusion of digital recording or any other similar means into any system, to be controlled simply by hand remote control, or by emplacement of a computer element to coordinate sound source with the graphics.

Application of options is clearly taught by present invention. For example, use of Platen as an independent artwork upon (or within) which artwork would be directly applied requires no unusual operational skills, but introduces an art mode in use and application of media not contemplated heretofore that would challenge any innovative artist. Laminated work (collage) described hereinbefore may be of any reasonable thickness and still easily be attachable to and displayed within artist's decorative frame. A pattern preprinted directly upon Platen for completion by an amateur artist needs no further clarification, as can be said of use of colored platens, even in multiplicity taught herein.

The inclusion within or on Platen or any appurtenances thereto of fluoreseable character, colored or not, is made notable when such inclusions are exposed to ultra-violet light generated in Ventilated Light Box, and that light source is varied in intensity by voltage controls, the fluorescent effects can be dramatic, indeed. Additionally, in similar teaching, light falling upon Platen, etc., from within can be dimmed/brightened simply by means of in-line rheostatic control, and further may be programmably timed to cause an artwork depicting a sunset to descend from brilliance gradually into afterglow. Similar effects may be achieved at will.

The introduction of artfully disposed fibrous elements into or onto Platen or any attachment thereto introduces still another completely new art skill, with unlimited scope of expression.

The progressive techniques, methods and skills taught by present invention encompassing Platen use are completely new and previously unknown to the art. They allow unprecedented flexibility of artistic expression and scope, and bring to the artistic community vast new opportunity.

B) ARTWORK CONTAINMENT FRAME (“Frame”) Part No. 11

Frame is a simple device designed merely to bring securely together the other three main elements of present invention. Its function allows no true dynamics, however it is integral to the absolute requirement of light reflection upon Platen, etc., and must be sufficiently sturdy to support Module proper without deflection. Thus, sectional dimensions may be altered to support Module exposure as necessary. Module parts are assembled in “sandwich” form, with Platen facing Viewer and secured to Frame, the Screens then fitted into back of Frame to be covered and held in place by Box. Nothing to it!

C) LIGHT DIFFUSION SCREEN(S) (“Screen”)—Part No. 12)

Function of Screen is to scatter, diffuse, disperse uniformly all light directed upon it (them) from Ventilated Light Box, although such light will already be widely dispersed by previous effective means. Present invention employs all such means to enable display of artworks to greatest advantage and enjoyment of viewer. Teachings of present invention include advantages gained by employment of a multiplicity of Screens, enabled by configuration of Artwork Containment Frame or obvious modification thereto.

In practice, Screen may be clear, white, colored or sectionally-colored or framedly focused at midportion or any other portion or portions of Screen, to limit light transmission to section(s) of artwork as may be desirable to meet dictates of artwork. An option to use of conventional diffusion screens is employment of or development of a screen or screens designed to focus light from the Ventilated Light Box centrally upon artwork.

D) VENTILATED LIGHT BOX (“BOX”)—Part No. 13

Subject element of Module permits wide-ranging imaginative excursions. Said Box in present invention is source of all light directed upon artwork, and thus may be fitted with a multiplicity of light sources of various types of emanations, and may be designed to direct such light centrally or to disperse uniformly all light emissions. Said Box may be provided with facility to embrace not only preferred embodiment of incandescent light bulbs, colored or not, but can be made to accomodate fluorescent bulbs, colored or not, such as commercially available short tubes, or “bulbs” inclusive of ballasts enclosed within their bases; infrared bulbs; neon tube light elements colored or not, with transformers; ultraviolet bulbs; halogen and other light sources. Production of unusual light may be provided by means of coating interior of Box with medium that will fluoresce when exposed to ultraviolet light.

In preferred embodiment light sources within Box ideally are controlled by means of an in-line dimmer control, but may be turned on or off simply by means of an in-line switch located at Module. Lighting may be controlled by means of control programmed to conform to artwork display sequential needs, and may be made to illuminate or turn off by means of a timer. An innovative option is to install light bulbs in the primary colors and control their brightness individually by means of dimmer controls (with computer control or not). Using this method, viewer may adjust light falling upon artwork to any intensity, of any color, of any shading (this utilization of light control would produce an even more admirable sunset progression than described earlier herein—it truly would “come alive!”).

It is notable that the 20-degree slope angle cited earlier in this description causes light emitted from light sources (masked as hereinbefore described) to impinge upon all rear and side surfaces of Box to be mixed and diffused prior to being directed upon Light Diffusion Screen(s). Ventilation is effected by means of convective routing, which employs vent holes in exterior of the Box at bottom for new air entry, and matching holes in exterior of the Box at top for air exit. Ventilation Flues (Part No. 14) covering all such vent holes discourage light exit that would distract viewer.

### DESCRIPTION AND OPERATION, ALTERNATIVE EMBODIMENTS

1) ARTWORK DISPLAY PLATEN (“PLATEN”) PART NO. 10

An option to prererred embodiment is employment of PLATEN itself as an independent artwork, upon or within which is imposed artwork of any description. A new art media is introduced hereby, in which application of paints, acrylics, chalks, pencils, etc. must be modified in order to render necessary translucency.

A further option to the PLATEN is lamination fo two or more sheets of a translucent medium, either similar or dissimilar in: Color; in physical and light transferral properties; of same or differing geometry and perimeteral dimensions; or, any other features compatible to such laminating.

A further PLATEN option, as one of several related examples possible, teaches of an PLATEN being either clear of colored and preprinted with or otherwise defined designs for artistic direction.

A further option is PLATEN that is colored, either wholly or in varicolored sections, to provide a background for artistic media application.

A further option is the incorporation into or onto the PLATEN, or a laminated variation thereof, of a substance caused to fluoresce when exposed to an ultra-violet or equivalent light source that is situate within Ventilated light box (PART No. 13), which part is described herein later.

A furhter optional PLATEN is built upon by additional sheets. or partial sheets of same or differing translucent materials, clored or white, or clear or opaque, as would be a work of stained glass, or an Artistic Collage.

A further option has all perimetral edges silvered or otherwise coated with any paint, foil, plastic, etc., that will defeat light exit from such edges and will redirect such light back into PLATEN proper. It is well known that perimetral edges of many plastics and other such materials, when light is directed upon their surfaces, will discharge light brightly.

A further option to PLATEN allows light to exit its edges into a picture frame which, if translucent at perimeter of PLATEN, will be caused to glow.

A further option is bevelling or rounding downward the perimetral edges of PLATEN to surface level of frame, which configuration will surround the artwork with a thin “LIGHT FRAME”. Especially when PLATEN is made of plastic material.

A further option to PLATEN is attachment to surface facing viewer of a narrow relector strip closely to edge of PLATEN, that will direct light outwardly onto adjacent surfaces of picture frame (which may or may not be translucent or reflective). Said reflector strip is made of any rigid material made reflective by means of back-coating, plating or any other effective means, has either curved or flat section such as to reflect light from surface of PLATEN laterally onto the picture frame, without exposing such light to viewer.

A further PLATEN option contains wires, threads, fibers, or any other such filmentary means, disposed in any artful curvilinear or rectilnear or rectilinear manner fixed or loosely ordered to deliver enjoyment to viewer. Said fibrous means may or may not be colored, and may be sandwiched between two or more sheets of laminated means. A new Artistic direction is enabled by such means.

A further option to PLATEN is inclusion onto or into any PLATEN, filaments of metallic, ceramic or any other substance conductive to electricity. Such filamentary devices may cause PLATEN areas affected thereby to react in color when power is directed therein, notably when PLATEN contains elements permitting such light emanations, and/or when power is applied by means of controllable circuitry such as computer chips which themselves may be controlled remotely.

A further option imposes upon, into or within the PLATEN or laminations of PLATEN, a digital clock face and/or any chart-like or grid-like pattern, perhaps reactive to electricity, useful to commercial and/or military interests, to be varied as called for by human remote control, which control may be directed by means of computer chip(s) situate on or within PLATEN or Ventilated box assembly (PART No. 13). Endless interconnections of such conductors are possible and practical, to be controlled in production of visual effects desired. Module containing such PLATEN ideally would be mounted upon an easel.

A further option is reciprocal slidability to facilitate alternate or successive viewing of a multiplicity of PLATENS. Such slidable means are well known and may be attached to front face of artwork containment frame (PART No. 11) into which a multiplicity of PLATENS may be fitted and alternated. A further option to such alternate/successive slideable means is a device to rotationally place PLATENS for viewing and may be disposed in either horizontal or vertical circulatory embodiment. Such rotational means are well known to the art, having been employed in projectors for photographic negatives, as one example.

A further option to any embodiment of PLATEN is introduction of a coordinated sound system to augment pleasure enjoyed by viewers of artwork, or to facilitate instruction and descriptions derived in commercial or military uses. Such sound systems may be controlled by remote control means that also may be used for visual displays.

a further option to PLATEN is roughening of work surfaces by means of emery paper, sandblasting, etching, grit, or any other effective means. Such treatment will cause art media discourage “SAG” by flowable media.

It is notable that art media applied to work face of PLATEN may easily be removed by means of spirits, water, rags, scraping or any other sutiable means. Thusly, a clean workpiece is made available to the artist to re-impose desired depictions, at will.

2) ARTWORK CONTAINMENT FRAME (“FRAME”) PART NO. 11

Optional to frame are planar suraces, at viewer face, widened to accomodate module to ornamental viewing frame such as a picture frame in order to fit a smaller module to a larger viewing frame said widened surface may be finished in such manner as to blend with (or contrast to) viewing frame surfaces proximate to face of module, perhaps to be covered by transparent or translucent sheet reactive to light or not, or by means of a coating of colored media.

A further option is multiple, interchangable frames dimensioned at front faces to accomodate PLANTENS of varying sizes and media types.

Importantly, frame may be rendered monolithic by application of sturdy corner braces, in the event large and/or heavy impositions require such benefit.

3) LIGHT DIFFUSION SCREEN (“SCREEN”) PART NO. 12

Optional screen is produced by substitution of styrene, glass, or other effective material for preferred acrylic.

A further option is use of white or colored sheet, either wholly or sectionally treated in one or more colors.

4) VENTILATED LIGHT BOX (“BOX”) PART NO. 13

Optionally, box is formed of sheet metal, opaque plastic, ceramic, organic or inorganic compositions, or any other material suited to the purpose and duty, and which is coated internally with reflective means such as silvering, paint, metallic paint, tin plating or any other suitable means.

A further option is the imposition of a dimnesioned sheet to rear, internal surface of box panel, fastened centrally by means of a machine screw with chrome-plated head passed through box back panel and secured externally by means of washer and nut extending nominally outward to rear, in order to discourage mechanical abrasion and impact damage to back outer surface of box.

A further option is substitution of a piano hinge for attachment flange on one side of box, or order to facilitate service access.

A further option is insertion and jointure of separate adaptor between box and an assembly of other components of entire artwork display means having dissimilr dimensions.

5) VENTILATION FLUES (“FLUE”) PART NO. 14

An optional construction of Ventilation flues is use of metallic wire screen, which must be black of dark in color, and fixed to body of box by means of solder, cement or adhesive, or any other effective means.

A further option is use of a rigid, solid material in forming of flue, interior surfaces of which are coated with a heat-tolerant black media, which flue is fixed to body of box by means of any suitable solder, weld, rivets, adhesive or cement or any other suitable bonding means or method.

A further option is replacement of flues at bottom of light box with one or more air blower(s) to force cool air into box proper.

6) LIGHT SOURCE PART NO. 15

Optional to coating of half-length of incandescent bulbs is substitution of rotatable relector “CAPS” such as those in wide use on night lights, mechanics' work lights, and the like.

Optional light sources are fluorescent, ultraviolet, infrared, neon, halogen or any other light source, colored or not.

A further optional light source is provided by means of coating interior of box with a medium caused to fluoresce when exposed to ultraviolet light.

A further option is use of light sources in the primary colors, that individually may be controlled by means of dimmer command, enabling viewer to adjust light falling upon artwork to any intensity, color or shading in order to intensify of diminish any effect desired (A sunset scene could be made to truly “COME ALIVE”.

7) LIGHT SOURCE SOCKET PART NO. 16

Options to preferred embodiment may be such as those supplied by ANGELO BROS. Co. (“SNAP-IN SOCKET”), or many conventional small lamp sockets or “Candelabra Bases” set on threaded nipples secured by exterior crossbars.

8) POWER CORD PART NO. 17

Options to conventional power cords include inclusion of dimmer device controlled by timer to permit increasing or decreasing light brilliance of artwork displays, as programmed to viewers pleasure.

A further option is use of threaded or press-on devices at power cord connections to VLB light sources.

A further option is use of “HARNESS” composition of cable, cords and wire connections.

9) LIGHT BOX ATTACHMENT FLANGE PART NO. 18

An alternate is substitution of a piano hinge for flange on one side of box.

A further option is flange secured to frame by means of clamping device such as spring clamp, rotatable clip, elastic compression, cinched strap, slidable or any other device effectively securing box to frame.

10) LIGHT BOX VENT HOLE PART NO. 20

An option to simple vent hole(s) is employment of blower(s) to force cool air into body of light box.

A further option is use of pre-cooled air forced into body of light box at bottom.

11) COMPRESSIBLE SPACER PART NO. 21

Optionally, spacer may be secured to front or to back edges of ADP, rather than being a separate element .

A further option is employment of one or more sheets of light diffusion screen to fill space between PLANTEN and mounting ledge of frame.

12) ARTWORK CLAMP PART NO. 22

Optional devices are available commercially to hold together two planar elements are spring clips and clamps, compression clamps, slide latches and the like.

### CONCLUSION, RAMIFICATIONS AND SCOPE OF INVENTION

It has been demonstrated herein that present invention conveys a wide array of inherent advantages not enjoyed previously by art relating to display of backlighted artwork, while description contains many specifications and options, these should not be construed as limitations on scope of invention. Many additional variations are implicit and possible.

Accordingly, scope of the invention should be determined not by embodiments made known and described herein, but by the appended claims and their legal equivalents.

1. An artwork display means for translucent artworks, comprising
a) A shallow back-lighted means.
b) A light diffusion means.
c) A frame means.
d) A platen means.

2. An artwork display means according to claim 1A.
a) the artwork display means of claim 1A whereby said device underlies art works.
b) the artwork display means of claim 1A whereby said device includes a shallow light box means formed of rigid heat-tolerant material.
a) the light box means of claim 2B wherein said light box means may be formed of a clear material.
b) the light box means of claim 2BA wherein said light box means may be treated to reflect light inwardly.
c) the light box means of claim 2B wherein said light box means may be formed of sheet metal.
d) the light box means of claim 2BC wherein said light box means may be coated internally with a light reflective means.
e) the light box means of claim 2B wherein said light box means slopes inwardly and backwardly.
f) the light box means of claim 28 wherein said light box means contains a multiplicity of light sources.
g) the light sources of claim 2BF wherein said light sources may be dimmable.
h) the light box means of claim 28 wherein said light box means is pierced by vent hole means at top and bottom.
i) the venthole means of claim 2BH wherein said vent holes are fitted with ventilation flue means to prevent light exit.
j) the light box means of claim 2B wherein said light box means has attachment flange means.
k) the light box means of claim 2BBJ wherein said attachment flange means are fixed into back of assembly of artwork display means.

3. An artwork display means according to claim 1B.
a) a light diffusion means formed of rigid translucent material.
a) the light diffusion means of claim 3A wherein said light diffusion means may be in thin sheet form with surface pattern designed to scatter light passing through said light diffustion means.
b) the light diffusion means of claim 3A whereby said light diffusion means may be fixed into assembly of artwork display means adjoining ventilated light box means.

4. An artwork display means according to claim 1C.
a) and artwork containment frame means formed of a rigid machineable material.
a) the artwork containment frame means of claim 4A wherein said artwork containment means is assembled of mitered lengths of framal elements.
b) the frame means of claim 4AA wherein said artwork containment fram is formed to permit fixing thereto of other members of artwork display means.
c) the frame means of claim 4A wherein said frame means has sides coated with light reflective means.

5. Artwork display means according to claim 1D.
a) a planar artwork display PLATEN means according to claim 5 formed of a translucent rigid material.
b) the PLATEN means of claim 5A wherein said artwork display means is dimensioned to fit into front of frame means facing viewer.
a) the PLATEN means of claim 5B wherein said artwork display PLATEN means may be of any thickness suitable for service required.
b) the PLATEN means of claim 5BA wherein said PLATEN means may be translucent, clear or colored.
c) the PLATEN means of claim 5B wherein said PLATEN means may be of single or compositly laminated.
d) the PLATEN means of claim 5A wherein said PLATEN means may contain compositions differing in color and other physical aspects.
e) the PLATEN means of claim 5BC wherein said PLATEN means may contain any filamentary means.
f) the PLATEN means of claim 5Bc wherein said PLATEN means may have artwork imposed directly upon or into it, itself becoming the artwork to be displayed.
g) the PLATEN means of claim 5C wherein by said PLATEN means may contain elements reactive to light.
